(19) United States
(12) Patent Application Publication
(10) Pub. No.: US 2019/0058756 A1
(43) Pub. Date: Feb. 21, 2019

(54) Method, Terminal, and System for Sending Office Document

(71) Applicant: Huawei Technologies Co., Ltd., Shenzhen (CN)

(72) Inventors: Shanfu Li, Shenzhen (CN); Kangmin Huang, Shenzhen (CN); Senyu Liu, Shenzhen (CN)

(21) Appl. No.: 16/168,290

(22) Filed: Oct. 23, 2018

Related U.S. Application Data
(63) Continuation of application No. PCT/CN2018/074461, filed on Jan. 29, 2018.

(30) Foreign Application Priority Data
Feb. 15, 2017 (CN) 201710081461.X

(51) Int. Cl. H04L 29/08; G06F 3/0481; H04L 12/58

(52) U.S. Cl. CPC H04L 67/06; H04L 51/08; G06F 3/04817

(57) ABSTRACT

A method and a terminal for sending an office document, where the method includes that a terminal receives a document sending instruction of a first user, the terminal determines to-be-sent content selected by the first user in a first document and a second user, and the second user is a user who receives the to-be-sent content, and the terminal sends the to-be-sent content to the second user using a sending application. Hence, after determining the to-be-sent content, the first user may instruct the terminal to perform sending, and after receiving the document sending instruction, the terminal automatically sends the to-be-sent content to the second user using the sending application in order to simplify an operation of the first user, thereby improving user experience.

### CROSS-REFERENCE TO RELATED APPLICATIONS

This application is a continuation of International Patent Application No. PCT/CN2018/074461 filed on Jan. 29, 2018, which claims priority to Chinese Patent Application No. 201710081461.X filed on Feb. 15, 2017. The disclosures of the aforementioned applications are hereby incorporated by reference in their entireties.

### TECHNICAL FIELD

This application relates to the field of terminal technologies, and in particular, to a method, a terminal, and a system for sending an office document.

### BACKGROUND

Currently, people are increasingly using office software (e.g., POWERPOINT (PPT), EXCEL, Word, and the like). The office software can be used to conveniently collate and present work content (for example, a PPT report) in order to better communicate with a working partner. In work, sharing of an office document has become indispensable.

When sending an office document (e.g. document with an extension such as .ppt/.xls/.doc, or the like), a user may send the office document to a specific object using some application software (for example, a mailbox, QQ, eSpace, and a web disk), may use an online document conversion service to convert the office document into a Hypertext Markup Language 5 (HTMLS) web page, and therefore share the office document to the Moments, or may selectively send some electronic content.

However, when editing or reading an office document 1, the user wants to send some content in the office document 1 to another person. In this case, the user needs to first create an office document 2, copy, to the office document 2, some content that the user wants to send, and then open the application software or mailbox that can be used to send the office document in order to send the office document 2 to the other person. In this process, user operations are complex. Consequently, user experience is relatively poor.

### SUMMARY

Embodiments of the present disclosure provide a method, a terminal, and a system for sending an office document in order to simplify an operation of sending some content of an office document by a user, thereby improving user experience.

According to a first aspect, an embodiment of the present disclosure provides a method for sending an office document, including after a terminal receives a document sending instruction of a first user, determining to-be-sent content that is selected by the first user and that is in a first document and a second user, where the first document is an office document that is being edited, and the second user is a user who receives the to-be-sent content, and sending, by the terminal, the determined to-be-sent content to the second user using a sending application, where the sending application is an application that is used to send the to-be-sent content.

In other approaches, when a user wants to send some content of an office document to another person, the user needs to create a document, copy the to-be-sent content to the newly created document, and then send the document to the other person using application software or a mailbox. The operation is extremely complex, and user experience is relatively poor. In contrast, in the method provided in this embodiment of the present disclosure, after determining the to-be-sent content, the first user may instruct the terminal to perform sending, and after receiving the document sending instruction, the terminal automatically sends the to-be-sent content to the second user using the sending application in order to simplify an operation of the first user, thereby improving user experience.

With reference to the first aspect, in a first possible implementation of the first aspect, before sending the to-be-sent content to the second user using a sending application, the terminal may further display indication information of at least one sending application such that the first user selects a sending application for sending the to-be-sent content. The indication information of the sending application may be an icon corresponding to the sending application and/or text description corresponding to the sending application. The terminal may display, to the first user, all or some applications that are installed on the terminal and that can be used to send the to-be-sent content in order to facilitate selection by the first user.

With reference to the first possible implementation of the first aspect, in a second possible implementation of the first aspect, when displaying indication information of a sending application, the terminal may display the indication information of the at least one sending application based on a user usage record, where the user usage record includes a quantity of times that the first user uses the sending application and/or a time when the first user uses the sending application.

For example, the terminal may display, based on the quantity of times that the first user uses the sending application, indication information of N sending applications that are used for a maximum quantity of times, the terminal may display indication information of M sending applications that are recently used by the first user, or the terminal may determine, based on the quantity of times that the first user uses the sending application and a status of a recently used sending application, a sending application recommended to the first user, and display indication information of the recommended sending application. Therefore, in the foregoing embodiment, the terminal may recommend, to the first user based on a usage habit of the first user, an application for sending the to-be-sent content in order to further simplify an operation of the first user.

Certainly, to meet requirements of the first user in different situations, the terminal may further display, under the instruction of the first user, indication information of all sending applications.

With reference to the first aspect, in a third possible implementation of the first aspect, before the terminal sends the to-be-sent content to the second user, the terminal may generate a second document, and store the to-be-sent content in the second document. Correspondingly, when sending the to-be-sent content to the second user, the terminal sends the second document to the second user using the sending application. In the foregoing embodiment, the terminal may automatically generate a second document, and send the second document to the second user, thereby further meeting a user requirement.

With reference to the third possible implementation of the first aspect, in a fourth possible implementation of the first aspect, after sending the second document to the second user, the terminal may further delete the second document in order to avoid occupying storage resources of the terminal to store a document that may not be reused.

With reference to the first aspect, in a fifth possible implementation of the first aspect, before the terminal sends the to-be-sent content to the second user using a sending application, the terminal may further send the to-be-sent content to a server such that the server generates a second document, and stores the to-be-sent content in the second document, the terminal receives a document link fed back by the server, where the document link is an address of the second document in the server, and the terminal sends the document link to the second user using the sending application. In some application scenarios, the terminal may send the to-be-sent content to the server, and the server stores the to-be-sent content in order to save storage resources of the terminal or facilitate sharing of the to-be-sent content to more users.

With reference to any one of the third to the fifth possible implementations of the first aspect, in a sixth possible implementation of the first aspect, a document type of the newly created second document is the same as that of the first document.

With reference to the first aspect, in a seventh possible implementation of the first aspect, before the terminal sends the to-be-sent content to the second user using a sending application, the terminal may further initially configure a default sending application, or set, based on a usage record of the first user or a selection of the first user, a default sending application for sending the to-be-sent content. Correspondingly, when the terminal sends the to-be-sent content to the second user using a sending application, the terminal sends the to-be-sent content to the second user using the default sending application.

According to a second aspect, an embodiment of the present disclosure provides a terminal, including a receiving module configured to receive a document sending instruction of a first user, a determining module configured to determine to-be-sent content that is selected by the first user and that is in a first document and a second user, where the first document is an office document that is being edited by the first user, and the second user is a user who receives the to-be-sent content, and a sending module configured to send the to-be-sent content to the second user using a sending application, where the sending application is an application that is used to send the to-be-sent content.

With reference to the second aspect, in a first possible implementation of the second aspect, the terminal further includes a display module configured to display indication information of at least one sending application before the sending module sends the to-be-sent content to the second user using a sending application such that the first user selects a sending application for sending the to-be-sent content, where the indication information includes an icon corresponding to the sending application and/or text description corresponding to the sending application. The sending module is further configured to send the to-be-sent content to the second user using the sending application selected by the first user.

With reference to the first possible implementation of the second aspect, in a second possible implementation of the second aspect, the display module is further configured to display the indication information of the at least one sending application based on a user usage record, where the user usage record includes a quantity of times that the first user uses the sending application and/or a time when the first user uses the sending application.

With reference to the second aspect, in a third possible implementation of the second aspect, the terminal further includes a generation module configured to generate a second document, and store the to-be-sent content in the second document before the sending module sends the to-be-sent content to the second user using a sending application. The sending module is further configured to send the second document to the second user using the sending application.

With reference to the third possible implementation of the second aspect, in a fourth possible implementation of the second aspect, the terminal further includes a deletion module configured to delete the second document after the sending module sends the second document to the second user using the sending application.

With reference to the second aspect, in a fifth possible implementation of the second aspect, the sending module is further configured to send the to-be-sent content to a server before sending the to-be-sent content to the second user using a sending application such that the server generates a second document, and stores the to-be-sent content in the second document. The receiving module is further configured to receive an address that is of the second document in the server and that is fed back by the server. When sending the to-be-sent content to the second user using the sending application, the sending module is further configured to send the address to the second user using the sending application.

With reference to any one of the third to the fifth possible implementations of the second aspect, in a sixth possible implementation of the second aspect, a document type of the second document is the same as that of the first document.

With reference to the second aspect, in a seventh possible implementation of the second aspect, the terminal further includes a configuration module configured to initially configure a default sending application, or set, based on a usage record of the first user or a selection of the first user, a default sending application for sending the to-be-sent content before the sending module sends the to-be-sent content to the second user using a sending application. The sending module is further configured to send the to-be-sent content to the second user using the default sending application.

According to a third aspect, an embodiment of the present disclosure provides another terminal, including a processor, and a memory and a transceiver that are separately connected to the processor.

The processor is configured to invoke a computer program that is pre-stored in the memory to perform the following steps of receiving a document sending instruction of a first user using the transceiver, determining to-be-sent content that is selected by the first user and that is in a first document and a second user, where the first document is an office document that is being edited by the first user, and the second user is a user who receives the to-be-sent content, and sending the to-be-sent content to the second user using a sending application, where the sending application is an application that is used to send the to-be-sent content.

With reference to the third aspect, in a first possible implementation of the third aspect, the terminal further includes a display, and before sending the to-be-sent content to the second user using a sending application, the processor is further configured to display indication information of at least one sending application using the display such that the first user selects a sending application for sending the to-be-sent content, where the indication information includes an icon corresponding to the sending application and/or text description corresponding to the sending application. When sending the to-be-sent content to the second user using a sending application, the processor is further configured to send the to-be-sent content to the second user using the sending application selected by the first user.

With reference to the first possible implementation of the third aspect, in a second possible implementation of the third aspect, when displaying indication information of a sending application, the processor is further configured to display, based on a user usage record, the indication information of the at least one sending application, where the user usage record includes a quantity of times that the first user uses the sending application and/or a time when the first user uses the sending application.

With reference to the third aspect, in a third possible implementation of the third aspect, before sending the to-be-sent content to the second user using a sending application, the processor is further configured to generate a second document, and store the to-be-sent content in the second document. When sending the to-be-sent content to the second user using a sending application, the processor is further configured to send the second document to the second user using the sending application.

With reference to the third possible implementation of the third aspect, in a fourth possible implementation of the third aspect, after sending the second document to the second user using the sending application, the processor is further configured to delete the second document.

With reference to the third aspect, in a fifth possible implementation of the third aspect, before sending the to-be-sent content to the second user using a sending application, the processor is further configured to send the to-be-sent content to a server such that the server generates a second document, and stores the to-be-sent content in the second document, and receive, using the transceiver, a document link fed back by the server, where the document link is an address of the second document in the server. When sending the to-be-sent content to the second user using a sending application, the processor is further configured to send the document link to the second user using the sending application.

With reference to any one of the third to the fifth possible implementations of the third aspect, in a sixth possible implementation of the third aspect, a document type of the second document is the same as that of the first document.

With reference to the third aspect, in a seventh possible implementation of the third aspect, before sending the to-be-sent content to the second user using a sending application, the processor is further configured to initially configure a default sending application, or set, based on a usage record of the first user or a selection of the first user, a default sending application for sending the to-be-sent content. When sending the to-be-sent content to the second user using a sending application, the processor is further configured to send the to-be-sent content to the second user using the default sending application.

According to a fourth aspect, an embodiment of the present disclosure provides a system for sending an office document, including the terminal according to the second aspect or the third aspect, and a receiving terminal configured to receive to-be-sent content.

According to a fifth aspect, an embodiment of the present disclosure provides a system for sending an office document, including the terminal according to the second aspect or the third aspect, and a server, where the server is configured to receive to-be-sent content sent by the terminal, generate a second document, and store the to-be-sent content in the second document, and return, to the terminal, a link of the second document in the server.

### BRIEF DESCRIPTION OF DRAWINGS

FIG. 1 is a schematic structural diagram of a terminal that is applicable to an embodiment of the present disclosure;

FIG. 2 is a schematic flowchart of a method for sending an office document according to an embodiment of the present disclosure;

FIG. 3 is a first embodiment according to an embodiment of the present disclosure;

FIG. 4 is a second embodiment according to an embodiment of the present disclosure;

FIG. 5 is a third embodiment according to an embodiment of the present disclosure;

FIG. 6 is a fourth embodiment according to an embodiment of the present disclosure;

FIG. 7 is a schematic structural diagram of a terminal according to an embodiment of the present disclosure;

FIG. 8 is a first schematic structural diagram of a system for sending an office document according to an embodiment of the present disclosure; and

FIG. 9 is a second schematic structural diagram of a system for sending an office document according to an embodiment of the present disclosure.

### DESCRIPTION OF EMBODIMENTS

Currently, learning resources, technical documents, and work reports are usually displayed as electronic documents, and sending and sharing of the electronic documents become indispensable during study and work. However, in some cases, content that a user wants to send and share may not be a whole document, and may be only a part of an existing document, and operations in the solution in the other approaches are extremely complex.

For example, a user A is reading an office document 1 with a large quantity of pages and relatively long content, and the user A considers that a part of the document is information that a user B is searching for, and wants to send this part to the user B. If the user A sends the whole document 1 to the user B, it is extremely difficult for the user B to find corresponding content in the document 1. Alternatively, the document 1 includes content that the user A does not want the user B to view, and therefore, the user A does not need to send the whole document 1 to user B. Therefore, if the user A wants to send only some content to the user B, the user A needs to first create an office document 2, name the document 2, copy related content from the document 1 to document 2, and then open application software to send the document 2 to the user B. An operation process is extremely complex.

To resolve the foregoing problem, this application provides a method, a terminal, and a system for sending an office document in order to simplify an operation of sending some content of an office document by a user, thereby improving user experience.

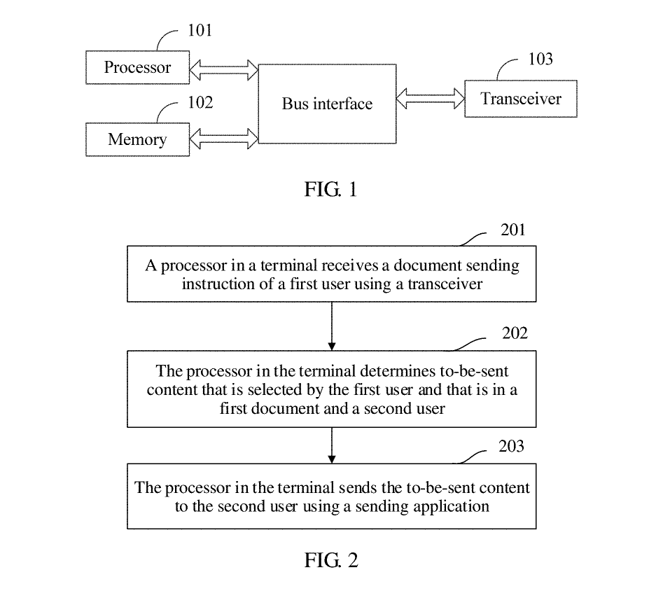

The terminal in this application may be user equipment that can be used to edit an electronic document (for example, an office document), such as a computer, a mobile phone, or a tablet computer. A schematic structural diagram of the terminal may be shown in FIG. 1, including a processor 101, and a memory 102 and a transceiver 103 that are separately connected to the processor 101. A person skilled in the art may understand that a structure of the terminal shown in FIG. 1 imposes no limitation on the terminal, and may include more or fewer components than those shown in FIG. 1, or combine some components, split some components, or have different component arrangements.

The processor 101 is a control center of the terminal, and is connected to parts of the entire terminal using various bus interfaces. The processor 101 performs various functions of the terminal and processes data by running or executing a software program and/or a module stored in the memory 102, and invoking data stored in the memory 102 in order to perform overall monitoring on the terminal.

The memory 102 may be configured to store a software program and a module. The processor 101 runs the software program and the module that are stored in the memory 102 in order to perform various functions and applications of the terminal and process data. The memory 102 may mainly include a program storage area and a data storage area. The program storage area may store an operating system, at least one application program that is required by a function, and the like, and the data storage area may store data that is created based on use of the terminal, and the like. In addition, the memory 102 may include a high-speed random access memory (RAM), or may include a non-volatile memory, such as at least one magnetic disk storage device, a flash storage device, or another volatile solid-state storage device.

The transceiver 103 is configured to receive or send data and information.

Further, the transceiver 103 may further include an input device and an output device. The input device is configured to input the data and the information to the terminal, and is one of main apparatuses for performing information exchange between the user and the terminal. The input device may be a keyboard, a mouse, a touch panel, a voice input apparatus, and the like. The output device is configured to display various data, information, or calculation results in a form of numerals, characters, images, and sounds. The output device may be a display panel, an image output system, a voice output system, or the like.

Referring to FIG. 2, FIG. 2 is a schematic flowchart of a method for sending an office document according to an embodiment of the present disclosure. As shown in the figure, the method includes the following steps.

Step 201: A processor in a terminal receives a document sending instruction of a first user using a transceiver.

When the first user is reading or editing a first document, and needs to send some content of the first document to a second user, the first user may send the document sending instruction to the terminal. The first document is an office document.

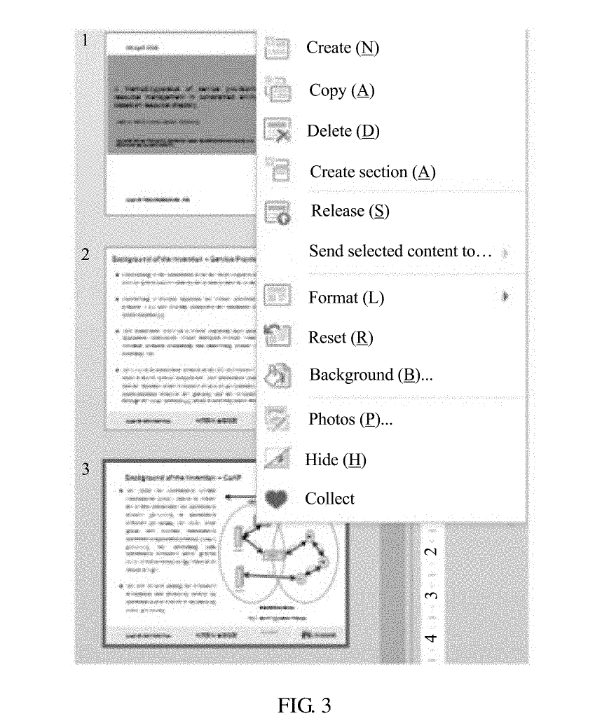

Embodiment 1: When a user A is using a computer to edit a PPT document, and considers that a user B may be interested in content in page 3 of the document, the user A may first select the page 3, and then right-click. Then, an option shown in FIG. 3 appears, and the user A may select “Send selected content to . . . ” to instruct the terminal to send the content on the page 3. Certainly, the user A may further simultaneously select a page 2 to a page 5 and instruct the terminal to perform sending.

Embodiment 2: When a user A is using a computer to edit an EXCEL document, and considers that a user B needs content in a sheet 2 of the document, the user A may select the tab page of the sheet 2, and then right-click. Then, an option similar to that in FIG. 3 may appear, and the user A selects “Send selected content to . . . ” to instruct the terminal to send the content in the sheet 2.

Embodiment 3: When a user A is using a computer to edit a Word document, and considers that content on a page 5 in the document is related to information that a user B is looking for, the user A may move a cursor to the page 5, and then right-click. Then, an option similar to that in FIG. 3 may appear, and the user A selects “Send selected content to . . . ” to instruct the terminal to send the content on the page 5.

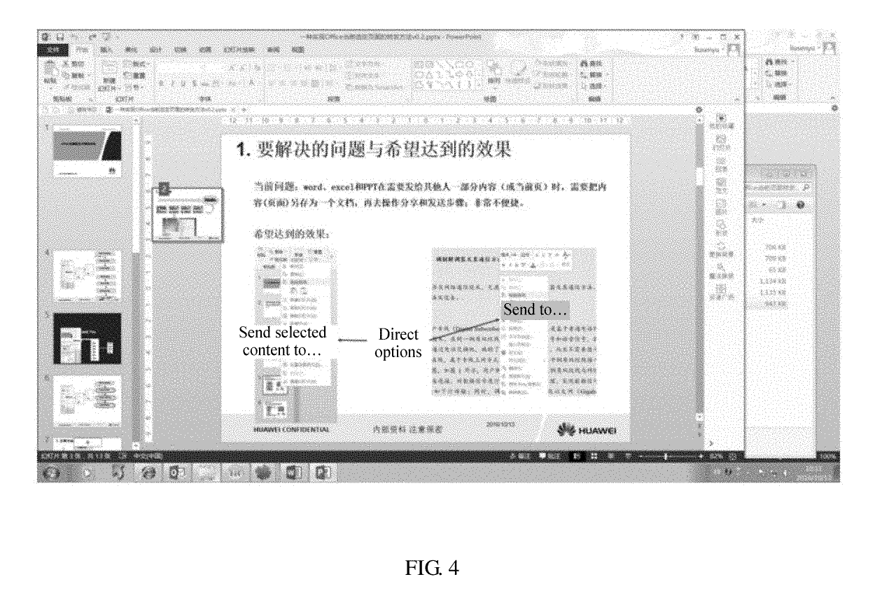

Embodiment 4: When a user A is using a computer to edit a PPT document, and considers that a user B may be interested in content on a page 3 of the document, as shown in FIG. 4, the user A may drag the page 3 to a chat window used for chatting with the user B, to instruct the terminal to send the content of the page 3 to the user B using the chat software.

Embodiment 5: When a user A is using a mobile phone to edit a PPT document, and considers that a user B may be interested in content on a page 5 of the document, the user A may use a voice instruction “Please send the page 5 in the current PPT” to instruct the terminal to send the content on the page 5.

Certainly, if content that the user wants to send is not content in one or more whole pages, the user may select only to-be-sent content, and instruct the terminal to perform sending. Not all examples are given one by one in this application.

Step 202: The processor in the terminal determines to-be-sent content that is selected by the first user and that is in a first document and a second user.

The first document is the office document that is currently being edited. When the processor in the terminal receives the document sending instruction, there may be a plurality of opened electronic documents, and the processor in the terminal needs to determine the to-be-sent content selected by the first user in the first document that is currently being edited. FIG. 3 is still used as an example. The processor in the terminal determines that the first user selects the page 3 of the PPT document that is currently being edited as the to-be-sent content. Alternatively, the processor in the terminal may use content on a page on which the cursor is located as the to-be-sent content. Alternatively, the processor in the terminal may determine the to-be-sent content based on a voice instruction of the first user. Alternatively, the processor in the terminal may use content dragged by the user as the to-be-sent content. Alternatively, the processor in the terminal may use content selected by the user as the to-be-sent content.

In a possible implementation, the processor in the terminal may further display, using an output device, indication information of at least one sending application to the first user. The first user may select a sending application from the indication information that is of the sending application and that is displayed by the terminal such that the terminal automatically performs sending using the sending application selected by the first user, and the first user does not need to perform operations of opening an application and sending a document in the opened application, thereby further simplifying an operation of the user.

The indication information of the sending application may be an icon of the sending application, text information, a link, or the like that can be distinguished from indication information of another sending application. Certainly, the indication information of the sending application may be a combination of the foregoing one or more types of information.

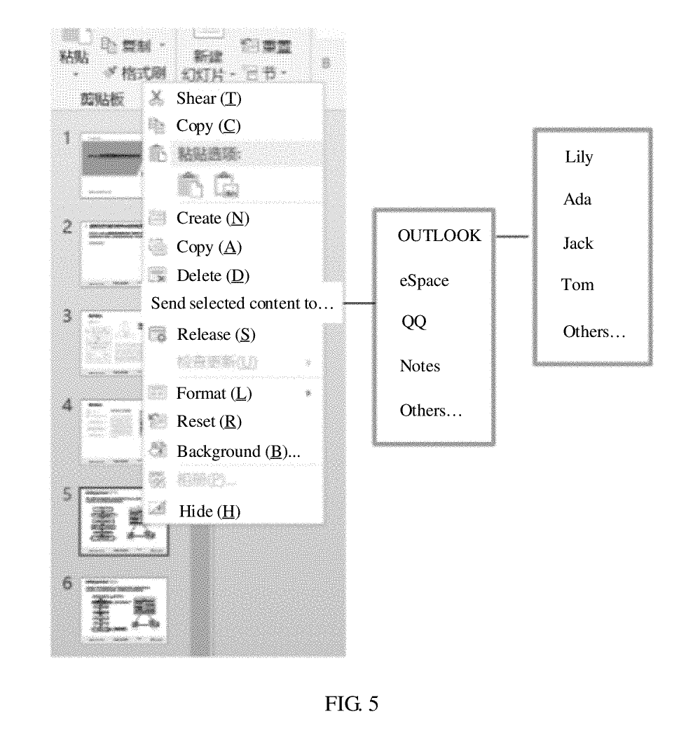

For example, after the first user selects “Send selected content to . . . ”, as shown in FIG. 5, indication information that is of an application and that can be used to send the to-be-sent content may be further displayed, for example, “OUTLOOK”, “eSpace”, “QQ”, and the like are displayed for the user to select an application for sending the to-be-sent content.

Further, when displaying the indication information of the sending application using the output device, the processor in the terminal may display the indication information of the at least one sending application based on a usage record of the user. The usage record of the user includes a quantity of times that the first user uses the sending application and/or a time when the first user uses the sending application.

For example, the processor in the terminal may determine, in the following manners, indication information of to-be-displayed sending applications.

Manner 1:

The processor in the terminal may sort the sending applications based on a quantity of times that the first user previously used various sending applications, and display, using the output device, indication information corresponding to the first N sending applications that are used for a relatively large quantity of times. N is an integer greater than or equal to 1.

Further, based on a total quantity of use times of various sending applications, or certainly, based on partial usage of various sending applications, for example, the processor in the terminal may sort the sending applications based on a quantity of times that the first user used various sending applications in the latest month, and determine the first N sending applications that are used for a relatively large quantity of times.

When the processor in the terminal displays the indication information of the first N sending applications that are used for a relatively large quantity of times, an “Others” option may be added. If an application corresponding to the displayed indication information of N sending applications is not an application that the user wants to use, the user may click “Others”, and the processor in the terminal displays all other sending applications using the output device. For example, if the processor in the terminal determines, based on a previous usage record, that the first four applications that are used for a maximum quantity of times are successively OUTLOOK, QQ, WECHAT, and eSpace, the processor in the terminal may successively display information about OUTLOOK, QQ, WECHAT, and eSpace, and the “Others” option using the output device.

Manner 2:

The processor in the terminal may sort the sending applications based on last usage times of various sending applications, and display, using the output device, indication information of M sending applications whose last usage times are relatively close, where M is an integer greater than or equal to 1.

For example, if recently used applications are successively QQ, WECHAT, OUTLOOK, eSpace, and the like in various sending applications based on a usage order, the processor in the terminal may successively display, using the output device, indication information corresponding to QQ, WECHAT, OUTLOOK, and eSpace, and the “Others” option.

Manner 3:

The processor in the terminal may further determine, based on the quantity of times that the first user uses the sending application and the usage time, indication information corresponding to a to-be-displayed sending application.

For example, the processor in the terminal may preferentially display a sending application that is recently used and a sending application that is used for a maximum quantity of times, or the processor in the terminal may sort, separately based on the quantity of times that the first user uses the sending application and a time sequence in which the first user uses the sending application, various sending applications, and performs a weighting operation on two groups of sorting results in order to determine a sorting status of displayed sending applications.

In the foregoing three manners, the processor in the terminal can recommend a sending application to the first user based on a usage habit of the first user such that the displayed applications satisfy a requirement of the first user as much as possible, thereby further simplifying an operation of the first user.

In a possible implementation, after the first user selects a sending application, the processor in the terminal may further display, using the output device, frequent contacts in the sending application selected by the first user, for the first user to select a target second user. Further, when the frequent contacts are displayed, the frequent contacts may be determined in the manner of determining to-be-displayed sending applications. FIG. 5 is still used as an example. When the user A selects OUTLOOK to perform sending, the processor in the terminal determines, in communication records in OUTLOOK, that contacts who are previously contacted most frequently are Lily, Ada, Jack, Tom, and the like. In this case, the processor in the terminal may successively display Lily, Ada, Jack, Tom, and “Others” using the output device. If the user wants to perform sending to a contact other than Lily, Ada, Jack, and Tom, the user A may click the “Others” option, and the processor in the terminal displays all contacts in OUTLOOK using the output device for the user A to select.

In another possible implementation, the processor in the terminal may further set a default sending application for sending to-be-sent content. Further, after receiving the document sending instruction using the input device, the processor in the terminal displays frequent contacts or all contacts of the first user in the default application using the output device, for the first user to select the second user who receives the sent content, and sends, using the default sending application, the to-be-sent content to the second user selected by the first user.

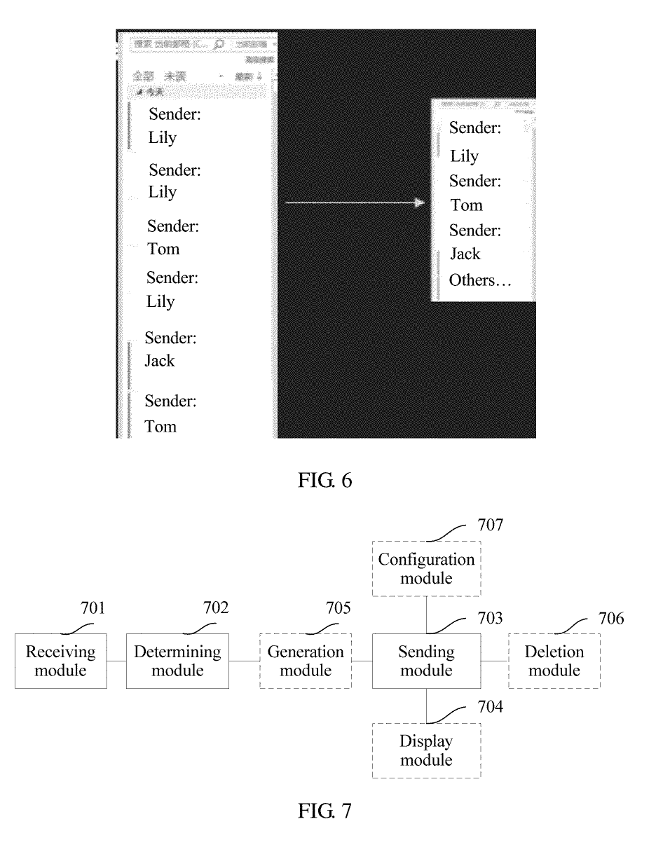

The default sending application may be preset by the terminal. For example, the processor in the terminal may set OUTLOOK as the default application, and the processor in the terminal sends the to-be-sent content to the second user using OUTLOOK each time after receiving the document sending instruction, certainly, alternatively, the processor in the terminal may automatically display the frequent contacts of the first user in OUTLOOK using the output device after receiving the document sending instruction, as shown in FIG. 6, and automatically send the to-be-sent content to the second user using OUTLOOK after the first user selects the second user. Alternatively, the default sending application may be set by the first user. The first user selects a sending application as the default sending application based on a usage habit of the first user. The terminal sends the to-be-sent content to the second user using the default application set by the first user. Alternatively, the default sending application may be automatically selected by the processor in the terminal based on a usage record of the first user and a preset selection rule, for example, the processor in the terminal may automatically select an application that is used for sending and that is used recently as the default application for sending the document.

Step 203: The processor in the terminal sends the to-be-sent content to the second user using a sending application.

In a possible implementation, before performing step 203, the processor in the terminal may automatically generate a second document in a back end, and store the to-be-sent content in the second document. Correspondingly, when performing step 203, the processor in the terminal sends the second document to the second user. In the foregoing method implementation, the first user does not need to perform operations of creating a document, naming the new document, and copying the to-be-sent content to the second document. The processor in the terminal automatically performs the operation in order to simplify a user operation, thereby improving user experience.

Optionally, when the processor in the terminal generates a second document, a document type of the generated second document is the same as that of the first document. For example, if the first document is a PPT document, a generated second document is also a PPT document, if the first document is an EXCEL document, a second document is also an EXCEL document, or if the first document is a Word document, a generated second document is also a Word document.

A document type of the second document generated by the processor in the terminal is the same as that of the first document such that when the to-be-sent content is stored in the second document, a format of the to-be-sent content in the first document can be retained in the second document as much as possible, thereby avoiding abnormal display of content in the second document because of an incompatible format.

Certainly, when generating the second document, the processor in the terminal may generate a second document of a default document type. For example, the processor in the terminal may generate a Word document by default. In this case, regardless of whether the first document is a Word document, an EXCEL document, or a PPT document, determined to-be-sent content is stored in the Word document. Alternatively, the processor in the terminal may generate an email by default. In this case, regardless of a document type of the first document, determined to-be-sent content is stored in a text part of the generated email.

When generating a second document, the processor in the terminal further needs to name the second document. For example, the processor in the terminal may set a name of the second document to “first document name_K^{th} page”, where K represents a quantity of pages of to-be-sent content in the first document, set a name of the second document to “first document name_first sentence of to-be-sent content”, or set a name of the second document to “first document name_second user name”, for example, “Learning information_Lily”, which means that some content in a learning information document is to be sent to Lily. There are various manners of naming a document, and this is not limited in this embodiment of the present disclosure.

Optionally, after sending the second document to the second user, the processor in the terminal may further delete the second document. Generally, content stored in a generated second document is only some content of the first document. After the second document is sent to the second user, the first user may not view the second document again, and therefore may delete the second document in order to avoid occupying storage resources of the terminal to store a document that may not be reused.

In another possible implementation, before performing step 203, the processor in the terminal may further send the to-be-sent content to a server using a transceiver such that the server generates a second document, and stores the to-be-sent content in the second document, and the processor in the terminal receives, using the transceiver, a document link fed back by the server, where the document link is an address of the second document in the server. Correspondingly, when performing step 203, the processor in the terminal sends the link of the second document in the server to the second user.

An office scenario is used as an example. Many companies have their own servers for storing and sharing internal information of the companies. After determining to-be-sent content, the processor in the terminal may send the to-be-sent content to the server, and after receiving the to-be-sent content, the server may generate a second document in the server, and store the to-be-sent content in the second document in order to save storage resources of the terminal and allow more internal personnel of the company to view the to-be-sent content using the server.

In a specific implementation, considering that the server may have an access permission problem, for example, the server of a company allows access from internal employees of the company, and an employee who does not work in the company cannot access the server, if an application used for communication between the internal employees of the company is installed on the terminal, the processor in the terminal may display the application that is used for internal communication of the company in the first place when displaying indication information of a sending application.

In the foregoing embodiment of the present disclosure, after determining to-be-sent content, the first user may instruct the terminal to perform sending, and after receiving the document sending instruction, the terminal pushes a sending application to the first user, and sends, using the application selected by the first user, the to-be-sent content to the second user selected by the first user in order to simplify an operation of the first user, thereby improving user experience.

Based on a same technical concept, an embodiment of the present disclosure further provides a terminal to implement the foregoing method embodiment. As shown in FIG. 7, the terminal includes a receiving module 701 configured to receive a document sending instruction of a first user, a determining module 702 configured to determine to-be-sent content that is selected by the first user and that is in a first document and a second user, where the first document is an office document that is being edited by the first user, and the second user is a user who receives the to-be-sent content, and a sending module 703 configured to send the to-be-sent content to the second user using a sending application, where the sending application is an application that is used to send the to-be-sent content.

Optionally, the terminal further includes a display module 704 configured to, before the sending module 703 sends the to-be-sent content to the second user using a sending application, display indication information of at least one sending application such that the first user selects a sending application for sending the to-be-sent content, where the indication information includes an icon corresponding to the sending application and/or text description corresponding to the sending application.

The sending module 703 is further configured to send the to-be-sent content to the second user using the sending application selected by the first user.

Optionally, the display module 704 is further configured to display the indication information of the at least one sending application based on a user usage record, where the user usage record includes a quantity of times that the first user uses the sending application and/or a time when the first user uses the sending application.

Optionally, the terminal further includes a generation module 705 configured to, before the sending module 703 sends the to-be-sent content to the second user using a sending application, generate a second document, and store the to-be-sent content in the second document.

The sending module 703 is further configured to send the second document to the second user using the sending application.

Optionally, the terminal further includes a deletion module 706 configured to delete the second document after the sending module 703 sends the second document to the second user using the sending application.

Optionally, the sending module 703 is further configured to, before sending the to-be-sent content to the second user using a sending application, send the to-be-sent content to a server such that the server generates a second document, and stores the to-be-sent content in the second document.

The receiving module 701 is further configured to receive an address that is of the second document in the server and that is fed back by the server.

When sending the to-be-sent content to the second user using the sending application, the sending module 703 is further configured to send the address to the second user using the sending application.

Optionally, a document type of the second document is the same as that of the first document.

Optionally, the terminal further includes a configuration module 707 configured to before the sending module 703 sends the to-be-sent content to the second user using a sending application, initially configure a default sending application, or set, based on a usage record of the first user or a selection of the first user, a default sending application for sending the to-be-sent content.

The sending module 703 is further configured to send the to-be-sent content to the second user using the default sending application.

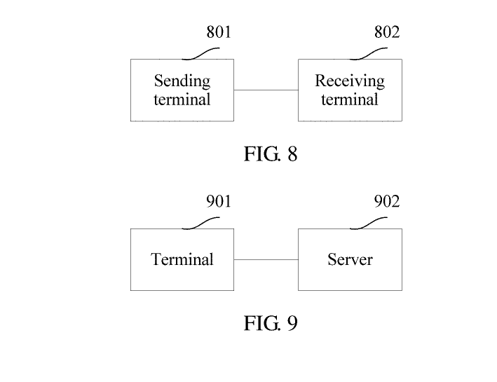

Based on a same technical concept, an embodiment of the present disclosure further provides a system for sending an office document to implement the foregoing method embodiment. As shown in FIG. 8, the system includes the foregoing terminal (that is, a sending terminal 801 shown in FIG. 8) and a receiving terminal 802 that is configured to receive to-be-sent content.

Based on a same technical concept, an embodiment of the present disclosure further provides a system for sending an office document to implement the foregoing method embodiment. As shown in FIG. 9, the system includes a terminal 901 and a server 902. The server 902 is configured to receive to-be-sent content sent by the terminal 901, generate a second document, and store the to-be-sent content in the second document, and return, to the terminal 901, a link of the second document in the server 902.

A person skilled in the art should understand that the embodiments of the present disclosure may be provided as a method, a system, or a computer program product. Therefore, the embodiments of the present disclosure may use a form of hardware only embodiments, software only embodiments, or embodiments with a combination of software and hardware. In addition, the embodiments of the present disclosure may use a form of a computer program product that is implemented on one or more computer-usable storage media (including but not limited to a disk memory, a compact disc read only memory (CD-ROM), an optical memory, and the like) that include computer-usable program code.

The embodiments of the present disclosure are described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine such that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner such that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device such that a series of operations and steps are performed on the computer or the other programmable device, thereby generating computer-implemented processing. Therefore, the instructions executed on the computer or the other programmable device provide steps for implementing a specific function in one or more processes in the flowcharts and/or in one or more blocks in the block diagrams.

Obviously, a person skilled in the art can make various modifications and variations to embodiments of the present disclosure without departing from the spirit and scope of this application. This application is intended to cover these modifications and variations provided that they fall within the scope of protection defined by the following claims and their equivalent technologies.

What is claimed is:

1. A method for sending an office document, comprising:
receiving, by a terminal, a document sending instruction of a first user; and
sending, by the terminal, to-be-sent content to a second user using a sending application, the to-be-sent content is selected by the first user in a first document, the first document comprising an office document edited by the first user, and the second user comprising a user who receives the to-be-sent content, the sending application comprising an application sending the to-be-sent content.

2. The method of claim 1, wherein before sending the to-be-sent content to the second user, the method further comprises displaying, by the terminal, indication information of at least one sending application to enable the first user to select the sending application for sending the to-be-sent content, the indication information comprising an icon corresponding to the sending application or text description corresponding to the sending application, and sending the to-be-sent content to the second user comprising sending, by the terminal, the to-be-sent content to the second user using the sending application selected by the first user.

3. The method of claim 2, wherein displaying the indication information of the at least one sending application comprises displaying, by the terminal, the indication information of the at least one sending application based on a user usage record, and the user usage record comprising a quantity of times that the first user uses the at least one sending application and a time when the first user uses the at least one sending application.

4. The method of claim 2, wherein displaying the indication information of the at least one sending application comprises displaying, by the terminal, the indication information of the at least one sending application based on a user usage record, and the user usage record comprising a quantity of times that the first user uses the at least one sending application.

5. The method of claim 2, wherein displaying the indication information of the at least one sending application comprises displaying, by the terminal, the indication information of the at least one sending application based on a user usage record, and the user usage record comprising a time when the first user uses the at least one sending application.

6. The method of claim 1, wherein before sending the to-be-sent content to the second user, the method further comprises:
generating, by the terminal, a second document; and
storing, by the terminal, the to-be-sent content in the second document, and
sending the to-be-sent content to the second user comprising sending, by the terminal, the second document to the second user using the sending application.

7. The method of claim 6, wherein after sending the second document to the second user, the method further comprises deleting, by the terminal, the second document.

8. The method of claim 1, wherein before sending the to-be-sent content to the second user, the method further comprises:
sending, by the terminal, the to-be-sent content to a server to enable the server to generate a second document and store the to-be-sent content in the second document; and
receiving, by the terminal, a document link from the server, the document link comprising an address of the second document in the server, and
sending the to-be-sent content to the second user comprising sending, by the terminal, the document link to the second user using the sending application.

9. The method of claim 6, wherein a document type of the second document comprises the same as that of the first document.

10. The method of claim 1, wherein before sending the to-be-sent content to the second user, the method further comprises initially configuring, by the terminal, a default sending application, and sending, by the terminal, the to-be-sent content to the second user comprising sending, by the terminal, the to-be-sent content to the second user using the default sending application.

11. The method of claim 1, wherein before sending the to-be-sent content to the second user, the method further comprises setting, by the terminal based on a usage record of the first user, a default sending application for sending the to-be-sent content, and sending, by the terminal, the to-be-sent content to the second user comprising sending, by the terminal, the to-be-sent content to the second user using the default sending application.

12. The method of claim 1, wherein before sending the to-be-sent content to the second user, the method further comprises setting, by the terminal based on a selection of the first user, a default sending application for sending the to-be-sent content, and sending, by the terminal, the to-be-sent content to the second user comprising sending, by the terminal, the to-be-sent content to the second user using the default sending application.

13. A terminal, comprising:
a memory comprising a program;
a transceiver coupled to the memory; and
a processor coupled to the memory and the transceiver, the program in the memory causing the processor to be configured to:
receive a document sending instruction of a first user using the transceiver;
determine to-be-sent content in a first document and a second user selected by the first user, the first document comprising an office document edited by the first user, and the second user comprising a user who receives the to-be-sent content; and
send the to-be-sent content to the second user using a sending application, the sending application comprising an application sending the to-be-sent content.

14. The terminal of claim 13, further comprising a display coupled to the processor, and before sending the to-be-sent content to the second user, the program further causes the processor to be configured to:
display indication information of at least one sending application using the display to enable the first user to select the sending application for sending the to-be-sent content, the indication information comprising an icon corresponding to the sending application or text description corresponding to the sending application; and
send the to-be-sent content to the second user using the sending application selected by the first user when sending the to-be-sent content to the second user using the sending application.

15. The terminal of claim 14, wherein when displaying the indication information of the at least one sending application, the program further causes the processor to be configured to display, based on a user usage record, the indication information of the at least one sending application using the display, and the user usage record comprising a quantity of times that the first user uses the at least one sending application or a time when the first user uses the at least one sending application.

16. The terminal of claim 13, wherein before sending the to-be-sent content to the second user, the program further causes the processor to be configured to:
generate a second document; and
store the to-be-sent content in the second document, and
in response to sending the to-be-sent content to the second user, the program further causes the processor to be configured to send the second document to the second user using the sending application.

17. The terminal of claim 16, wherein after sending the second document to the second user, the program further causes the processor to be configured to delete the second document.

18. The terminal of claim 13, wherein before sending the to-be-sent content to the second user, the program further causes the processor to be configured to:
send the to-be-sent content to a server using the transceiver to enable the server to generate a second document and store the to-be-sent content in the second document; and
receive, using the transceiver, a document link from the server, the document link comprising an address of the second document in the server; and
in response to sending the to-be-sent content to the second user, the program further causes the processor to be configured to send the document link to the second user using the sending application.

19. The terminal of claim 16, wherein a document type of the second document comprises the same as that of the first document.

20. The terminal of claim 13, wherein before sending the to-be-sent content to the second user, the program further causes the processor to be configured to:
initially configure a default sending application; or
set, based on a usage record of the first user or a selection of the first user, a default sending application for sending the to-be-sent content, and
in response to sending the to-be-sent content to the second user, the program further causes the processor to be configured to send the to-be-sent content to the second user using the default sending application.
